(19) United States
(12) Patent Application Publication
(10) Pub. No.: US 2012/0105612 A1
(43) Pub. Date: May 3, 2012

(54) IMAGING APPARATUS, ENDOSCOPE APPARATUS, AND IMAGE GENERATION METHOD

(75) Inventor: Koichiro Yoshino, Tokyo (JP)

(73) Assignee: OLYMPUS CORPORATION, Tokyo (JP)

(21) Appl. No.: 13/253,389

(22) Filed: Oct. 5, 2011

(30) Foreign Application Priority Data
Nov. 2, 2010 (JP) 2010-245908

(51) Int. Cl. H04N 5/232; H04N 7/18

(52) U.S. Cl. 348/65; 348/345; 348/E05.045; 348/E07.085

(57) ABSTRACT

An imaging apparatus includes an image acquisition section, an exposure adjustment section, and a synthetic image generation section. The image acquisition section acquires a near point image in which a near-point object is in focus, and a far point image in which a far-point object positioned away as compared with the near-point object is in focus. The exposure adjustment section adjusts the ratio of the exposure of the near point image to the exposure of the far point image. The synthetic image generation section generates a synthetic image based on the near point image and the far point image acquired with exposure for which the ratio is adjusted.

Japanese Patent Application No. 2010-245908 filed on Nov. 2, 2010, is hereby incorporated by reference in its entirety,

### BACKGROUND

The present invention relates to an imaging apparatus, an endoscope apparatus, an image generation method, and the like,

An imaging apparatus (e.g., endoscope) is desired to generate a deep-focus image in order to facilitate diagnosis performed by the doctor. The deep-focus performance of an imaging apparatus (e.g., endoscope) is implemented by increasing the depth of field using an optical system having a relatively large F-number.

### SUMMARY

According to one aspect of the invention, there is provided an imaging apparatus comprising:

an image acquisition section that acquires a near point image in which a near-point object is in focus, and a far point image in which a far-point object is in focus, the far-point object being positioned away as compared with the near-point object;

an exposure adjustment section that adjusts a ratio of exposure of the near point image to exposure of the far point image; and

a synthetic image generation section that selects a first area that is an in-focus area in the near point image and a second area that is an in-focus area in the far point image to generate a synthetic image,

the synthetic image generation section generating the synthetic image based on the near point image and the far point image acquired with exposure for which the ratio is adjusted.

According to another aspect of the invention, there is provided an endoscope apparatus comprising:

an image acquisition section that acquires a near point image in which a near-point object is in focus, and a far point image in which a far-point object is in focus, the far-point object being positioned away as compared with the near-point object;

an exposure adjustment section that adjusts a ratio of exposure of the near point image to exposure of the far point image; and

a synthetic image generation section that selects a first area that is an in-focus area in the near point image and a second area that is an in-focus area in the far point image to generate a synthetic image,

the synthetic image generation section generating the synthetic image based on the near point image and the far point image acquired with exposure for which the ratio is adjusted.

According to another aspect of the invention, there is provided an image generation method comprising:

acquiring a near point image in which a near-point object is in focus, and a far point image in which a far-point object is in focus, the far-point object being positioned away as compared with the near-point object;

adjusting a ratio of exposure of the near point image to exposure of the far point image;

selecting a first area that is an in-focus area in the near point image and a second area that is an in-focus area in the far point image to generate a synthetic image; and

generating the synthetic image based on the near point image and the far point image acquired with exposure for which the ratio is adjusted.

### BRIEF DESCRIPTION OF THE DRAWINGS

FIG. 1 shows a first configuration example of an endoscope system.

FIG. 2 shows an example of a Bayer color filter array.

FIG. 3A is a view illustrative of the depth of field of a near point image, and FIG. 3B is a view illustrative of the depth of field of a far point image.

FIG. 4 shows a specific configuration example of an image processing section.

FIG. 5 shows a specific configuration example of a synthetic image generation section.

FIG. 6 shows a local area setting example during a sharpness calculation process.

FIG. 7 is a view illustrative of a normal observation state.

FIG. 8A is a schematic view showing a near point image acquired in a normal observation state, FIG. 8B is a schematic view showing a far point image acquired in a normal observation state, and FIG. 8C is a schematic view showing a synthetic image generated in a normal observation state.

FIG. 9 shows a second configuration example of an endoscope system.

FIG. 10 is a view illustrative of a magnifying observation state.

FIG. 11A is a schematic view showing a near point image acquired in a magnifying observation state when α=0.5, FIG. 11B is a schematic view showing a far point image acquired in a magnifying observation state when α=0.5, and FIG. 11C is a schematic view showing a synthetic image generated in a magnifying observation state when α=0.5.

FIG. 12A is a schematic view showing a near point image acquired in a magnifying observation state when α=1, FIG. 12B is a schematic view showing a far point image acquired in a magnifying observation state when α=1, and FIG. 12C is a schematic view showing a synthetic image generated in a magnifying observation state when α=1.

FIG. 13 shows a third configuration example of an endoscope system.

FIG. 14 shows a second specific configuration example of a synthetic image generation section.

### DESCRIPTION OF EXEMPLARY EMBODIMENTS

In recent years, an imaging element having about several hundred thousand pixels has been used for endoscope systems. The depth of field of an imaging apparatus is determined by the size of the permissible circle of confusion. Since an imaging element having a large number of pixels has a small pixel pitch and a small permissible circle of confusion, the depth of field of the imaging apparatus decreases. In this case, the depth of field may be maintained by reducing the aperture of the optical system, and increasing the F-number of the optical system.

According to this method, however, the optical system darkens, and noise increases, so that the image quality deteriorates. Moreover, the effect of diffraction increases as the F-number increases, so that the imaging performance deteriorates. Accordingly, a high-resolution image cannot be obtained even if the number of pixels of the imaging element is increased. The depth of field may be increased by acquiring a plurality of images that differ in in-focus object plane, and generating a synthetic image with an increased depth of field by synthesizing only the in-focus areas of the images (see JP-A-2000-276121).

An imaging element having a large number of pixels has a low pixel saturation level due to a small pixel pitch. As a result, the dynamic range of the imaging element decreases. This makes it difficult to capture a bright area and a dark area included in an image with correct exposure when the difference in luminance between the bright area and the dark area is large. The dynamic range may be increased by acquiring a plurality of images that differ in exposure, and generating a synthetic image with an increased dynamic range by synthesizing only the areas of the images with correct exposure (see JP-A-5-64075).

It is necessary to increase the depth of field and the dynamic range of an imaging apparatus (e.g., endoscope) in order to implement deep-focus observation with correct exposure. For example, a plurality of images (input images) may be acquired while changing the in-focus object plane and the exposure, and a synthetic image with an increased depth of field and an increased dynamic range may be generated using the input images. In order to generate such a synthetic image, the input images must be images acquired in a state in which at least part of the object is in focus with correct exposure.

Several aspects of the embodiment may provide an imaging apparatus, an endoscope apparatus, an image generation method, and the like that can generate an image with an increased depth of field and an increased dynamic range.

According to one embodiment of the invention, there is provided an imaging apparatus comprising:

an image acquisition section that acquires a near point image in which a near-point object is in focus, and a far point image in which a far-point object is in focus, the far-point object being positioned away as compared with the near-point object;

an exposure adjustment section that adjusts a ratio of exposure of the near point image to exposure of the far point image; and

a synthetic image generation section that selects a first area that is an in-focus area in the near point image and a second area that is an in-focus area in the far point image to generate a synthetic image,

the synthetic image generation section generating the synthetic image based on the near point image and the far point image acquired with exposure for which the ratio is adjusted.

According to one aspect of the embodiment, the ratio of the exposure of the near point image to the exposure of the far point image is adjusted, and the near point image and the far point image for which the exposure ratio is adjusted are acquired. A synthetic image is generated based on the acquired near point image and far point image. This makes it possible to generate a synthetic image with an increased depth of field and an increased dynamic range.

Exemplary embodiments of the invention are described below. Note that the following exemplary embodiments do not in any way limit the scope of the invention laid out in the claims. Note also that all of the elements of the following exemplary embodiments should not necessarily be taken as essential elements of the invention.

### 1. Outline

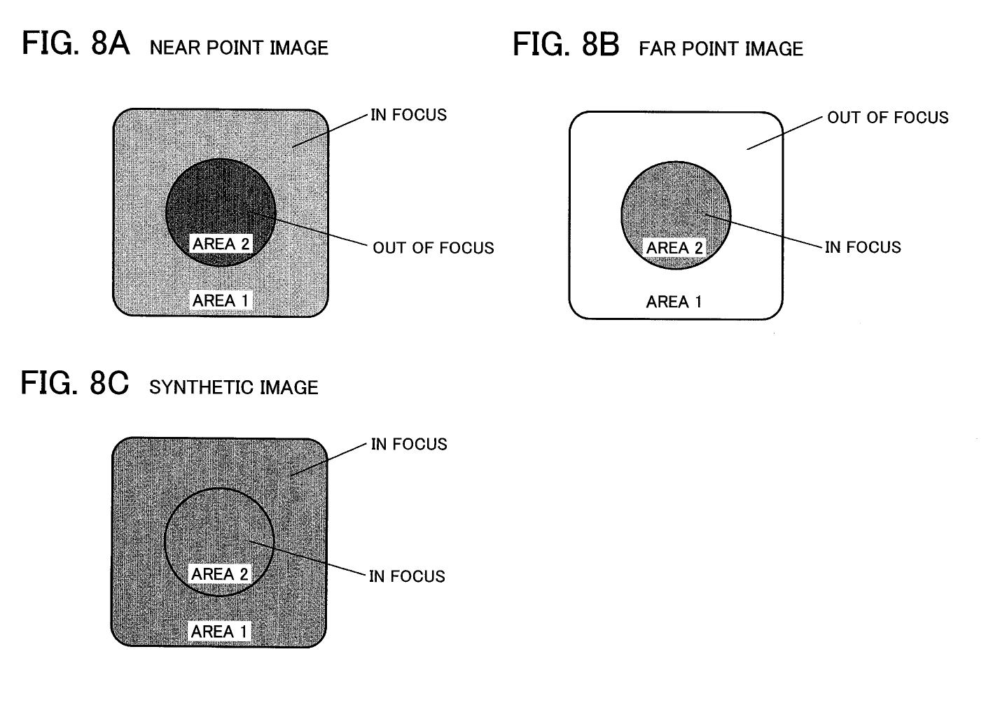

An outline of one embodiment of the invention is described below with reference to FIGS. 7 and 8A to 8C. As shown in FIG. 7, when imaging the inner wall of the digestive tract using an endoscope, the inner wall of the digestive tract is illuminated during imaging. Therefore, an object positioned away from the imaging section is displayed (imaged) darkly, so that the visibility of the object may deteriorate. For example, an object positioned close to the imaging section may show blown out highlights due to overexposure, and an object positioned away from the imaging section may be subjected to underexposure (i.e., the SDN ratio may deteriorate).

The visibility of the object may deteriorate when a deep-focus state cannot obtained. The deep-focus state refers to a state in which the entire image is in focus. For example, the depth of field of the imaging section decreases when a large F-number cannot be implemented due to a reduction in pixel pitch along with an increase in the number of pixels of the imaging element, the diffraction limit, and the like. An object positioned close to or away from the imaging section is out of focus (i.e., only part of the image is in focus) when the depth of field decreases.

In order to improve the visibility of an object positioned at an arbitrary distance from the imaging section (e.g., an object positioned close to the imaging section and an object positioned away from the imaging section), it is necessary to increase the dynamic range (i.e., a range in which correct exposure can be obtained), and increase the depth of field (i.e., a range in which the object is brought into focus).

Therefore, as shown in FIG. 7, a near point image that is in focus within a depth of field DF1, and a far point image that is in focus within a depth of field DF2 are captured. Since an object positioned close to the imaging section is illuminated brightly, an object within the depth of field DF1 is captured brightly as compared with an object within the depth of field DF2. As shown in FIG. 8A, an area 1 of a near point image corresponding to the depth of field DF1 (in focus) is captured with correct exposure. As shown in FIG. 8B, an area 2 of a far point image corresponding to the depth of field DF2 (in focus) is captured with correct exposure. The exposure adjustment is performed by capturing the near point image with small exposure as compared with the far point image. As shown in FIG. 8C, a synthetic image with an increased depth of field and an increased dynamic range is generated by synthesizing the area 1 of the near point image and the area 2 of the far point image.

### 2. Endoscope System

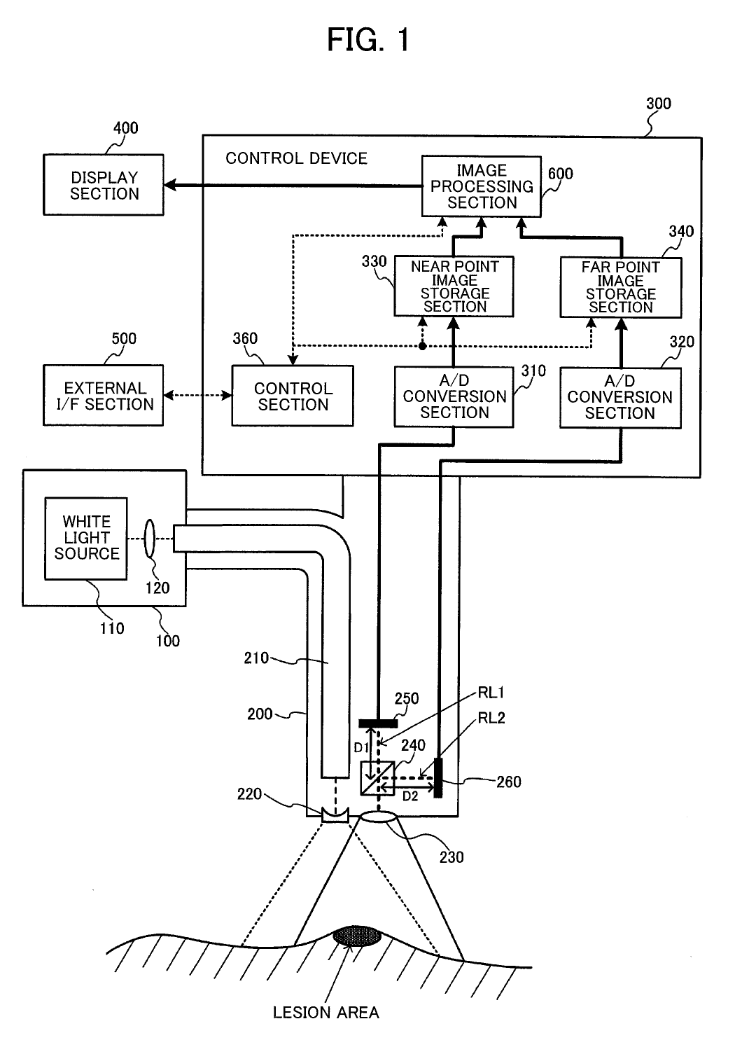

Exemplary embodiments of the invention are described in detail below. FIG. 1 shows a first configuration example of an endoscope system. The endoscope system (endoscope apparatus) shown in FIG. 1 includes a light source section 100, an imaging section 200, a control device 300 (processing section), a display section 400, and an external I/F section 500.

The light source section 100 includes a white light source 110 that emits white light, and a condenser lens 120 that focuses the white light on a light guide fiber 210.

The imaging section 200 is formed to be elongated and flexible (i.e., can be curved) so that the imaging section 200 can be inserted into a body cavity or the like. The imaging section 200 includes the light guide fiber 210 that guides light focused by the light source section 100, and an illumination lens 220 that diffuses light that has been guided by the light guide fiber 210, and illuminates an object. The imaging section 200 also includes an objective lens 230 that focuses light reflected by the object, an exposure adjustment section 240 that divides the focused reflected light, a first imaging element 250, and a second imaging element 260.

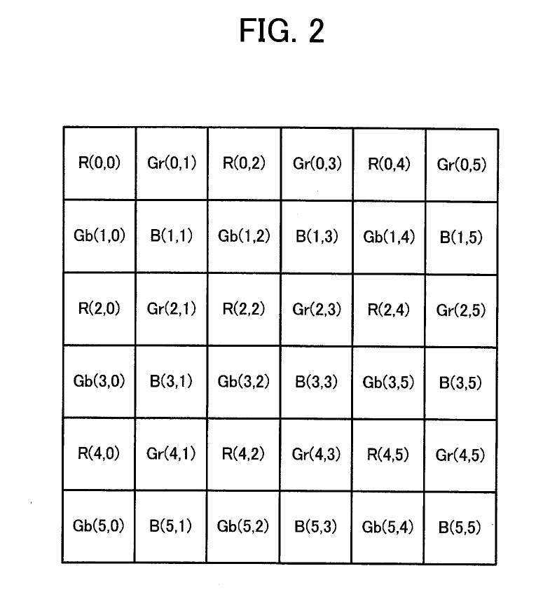

The first imaging element 250 and the second imaging element 260 include a Bayer color filter array shown in FIG. 2. Color filters Gr and Gb have the same spectral characteristics. The exposure adjustment section 240 adjusts the exposure of images acquired (captured) by the first imaging element 250 and the second imaging element 260. Specifically, the exposure adjustment section 240 divides the reflected light so that the ratio of the exposure of the first imaging element 250 to the exposure of the second imaging element 260 is a given ratio α. For example, the exposure adjustment section 240 is a beam splitter (division section in a broad sense), and divides the reflected light from the object so that α=0.5. Note that the ratio α is not limited to 0.5, but may be set to an arbitrary value.

The control device 300 (processing section) controls each element of the endoscope system, and processes an image. The control device 300 includes A/D conversion sections 310 and 320, a near point image storage section 330, a far point image storage section 340, an image processing section 600, and a control section 360.

The A/D conversion section 310 converts an analog signal output from the first imaging element 250 into a digital signal, and outputs the digital signal. The A/D conversion section 320 converts an analog signal output from the second imaging element 260 into a digital signal, and outputs the digital signal. The near point image storage section 330 stores the digital signal output from the A/D conversion section 310 as a near point image. The far point image storage section 340 stores the digital signal output from the A/D conversion section 320 as a far point image. The image processing section 600 generates a display image from the stored near point age and far point image, and outputs the display image to the display section 400. The details of the image processing section 600 are described later. The display section 400 is a display device such as a liquid crystal monitor, and displays the image output from the image processing section 600. The control section 360 is bidirectionally connected to the near point image storage section 330, the far point image storage section 340, and the image processing section 600, and controls the near point image storage section 330, the far point image storage section 340, and the image processing section 600.

The external I/F section 500 is an interface that allows the user to input information to the endoscope system, for example. The external I/F section 500 includes a power supply switch (power supply ON/OFF switch), a shutter button (photographing operation start button), a mode (e.g., photographing mode) switch button, and the like. The external I/F section 500 outputs information input by the user to the control section 360.

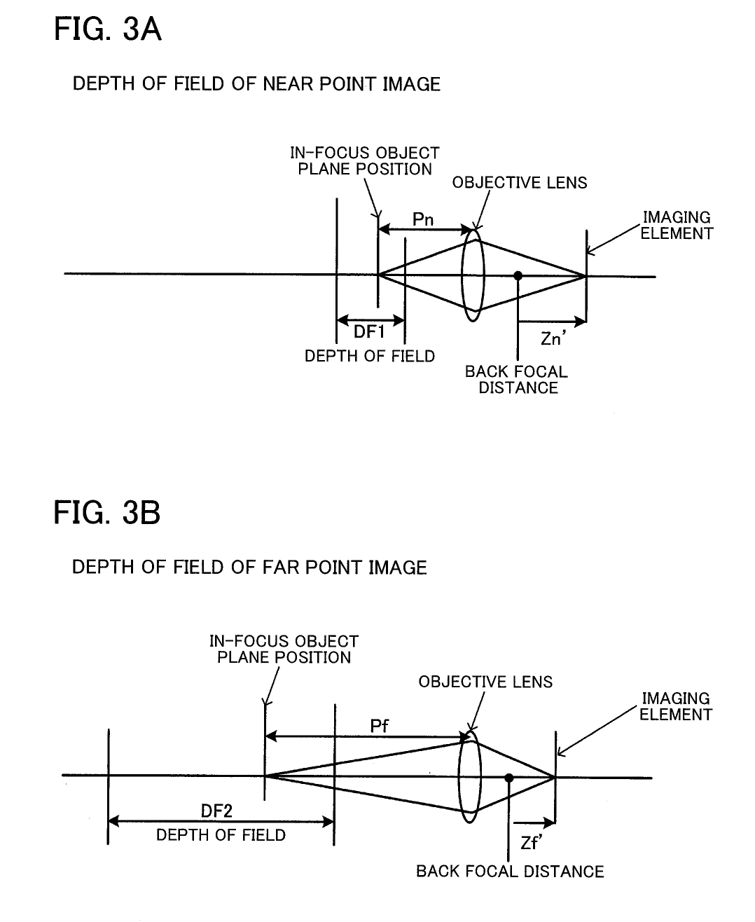

The depth of field of images acquired by the first imaging element 250 and the second imaging element 260 is described below with reference to FIGS. 3A and 3B. In FIG. 3A, Zn′ indicates the distance from the back focal distance of the objective lens 230 to the first imaging element 250. In FIG. 3B, Zf′ indicates the distance from the back focal distance of the objective lens 230 to the second imaging element 260. The first imaging element 250 and the second imaging element 260 are disposed so that Zn′>Zf′ through the exposure adjustment section 240, for example Therefore, a depth of field DF1 of the near point image acquired by the first imaging element 250 is close to the objective lens 230 as compared with a depth of field DF2 of the far point image acquired by the second imaging element 260. The depth of field of each image can be adjusted by adjusting the values Zn′ and Zf′.

### 3. Image Processing Section

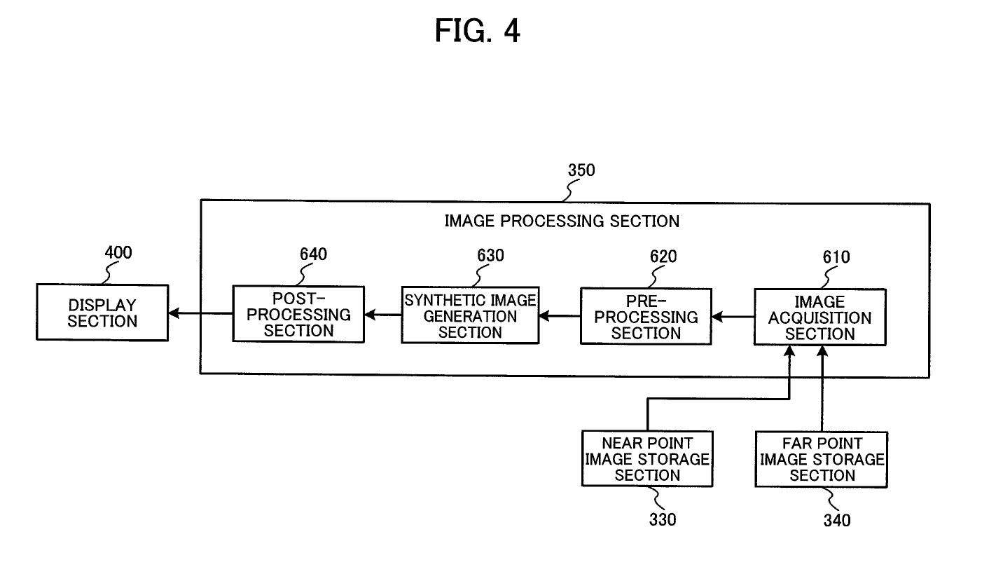

The image processing section 600 that outputs a synthetic image with an increased depth of field and an increased dynamic range is described in detail below. FIG. 4 shows a specific configuration example of the image processing section 600. The image processing section 600 includes an image acquisition section 610, a preprocessing section 620, a synthetic image generation section 630, and a post-processing section 640.

The image acquisition section 610 reads (acquires) the near point image stored in the near point image storage section 330 and the far point image stored in the far point image storage section 340. The preprocessing section 620 performs a preprocess (e.g., OB process, white balance process, demosaicing process, and color conversion process) on the acquired near point image and far point image, and outputs the near point image and the far point image subjected to the preprocess to the synthetic image generation section 630. The preprocessing section 620 may optionally perform a correction process on optical aberration (e.g., distortion and chromatic aberration of magnification), a noise reduction process, and the like.

The synthetic image generation section 630 generates a synthetic image with an increased depth of field using the near point image and the far point image output from the preprocessing section 620, and outputs the synthetic image to the post-processing section 640. The post-processing section 640 performs a grayscale transformation process, an edge enhancement process, a scaling process, and the like on the synthetic image output from the synthetic image generation section 630, and outputs the processed synthetic image to the display section 400,

### 4. Synthetic Image Generation Section

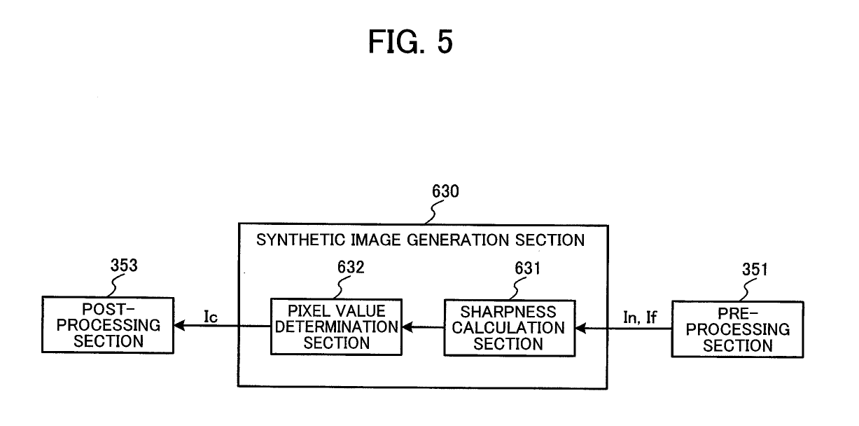

FIG. 5 shows a specific configuration example of the synthetic image generation section 630. The synthetic image generation section 630 includes a sharpness calculation section 631 and a pixel value determination section 632. The near point image input to the synthetic image generation section 630 is hereinafter referred to as In, and the far point image input to the synthetic image generation section 630 is hereinafter referred to as If. The synthetic image output from the synthetic image generation section 630 is hereinafter referred to as Ic.

The sharpness calculation section 631 calculates the sharpness of the near point image In and the far point image If output from the preprocessing section 620. Specifically, the sharpness calculation section 631 calculates the sharpness S_In(x, y) of a processing target pixel In(x, y) (attention pixel) positioned at the coordinates (x, y) of the near point image In and the sharpness S_If(x, y) of a processing target pixel If(x, y) positioned at the coordinates (x, y) of the far point image If. The sharpness calculation section 631 outputs the pixel values In(x, y) and If(x, y) of the processing target pixels and the calculated sharpness S_In(x, y) and S_If(x, y) to the pixel value determination section 632.

For example, the sharpness calculation section 631 calculates the gradient between the processing target pixel and an arbitrary peripheral pixel as the sharpness. The sharpness calculation section 631 may perform a filter process using an arbitrary high-pass filter (HPF), and may calculate the absolute value of the output value corresponding to the position of the processing target pixel as the sharpness.

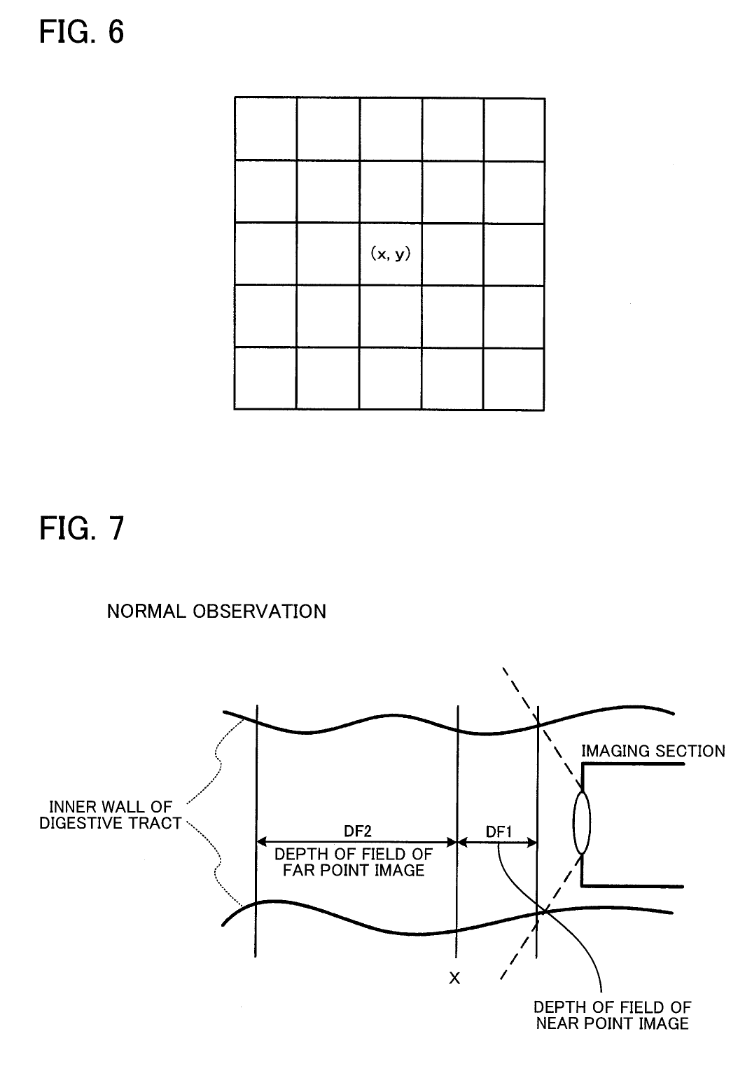

As shown in FIG. 6, the sharpness calculation section 631 may set a 5×5 pixel area around the coordinates (x, y) as a local area of each image, and may calculate the sharpness of the processing target pixels using the pixel value of the entire local area, for example. In this case, the sharpness calculation section 631 calculates gradients Δu, Δd, Δl, and Δr of each pixel of the local area set to the processing target pixels relative to four pixels adjacent to each pixel in the vertical direction or the horizontal direction using the pixel value of the G channel, for example. The sharpness calculation section 631 calculates the average values Δave_In and Δave_If of the gradients of each pixel of the local arean in the four directions to determine the sharpness S_In(x, y) and S_If(x, y) of the processing target pixels. The sharpness calculation section 631 may perform a filter process on each pixel of the local area using an arbitrary HPF, and may calculate the average value of the absolute values of the output values as the sharpness, for example.

The pixel value determination section 632 shown in FIG. 5 determines the pixel values of the synthetic image from the pixel values In(x, y) and If(x, y) and the sharpness S_In(x, y) and S_If(x, y) of the processing target pixels output from the sharpness calculation section 631 using the following expression (1), for example.

Ic(x, y)=In(x, y) when S_In(x, y)≧S_If(x, y),

Ic(x, y)=If(x, y) when S_In(x, y)<S_If(x, y) (1)

The sharpness calculation section 631 and the pixel value determination section 632 perform the above process on each pixel of the image while sequentially shifting the coordinates (x, y) of the processing target pixel to generate the synthetic image Ic. The pixel value determination section 632 outputs the generated synthetic image Ic to the post-processing section 640.

The synthetic image generated by the pixel value determination section 632 is described below with reference to FIGS. 7 to 8C. FIG. 7 shows a digestive tract normal observation state when using the endoscope system according to the first configuration example. FIGS. 8A and 8B schematically show a near point image and a far point image acquired in a normal observation state, and FIG. 8C schematically shows a synthetic image.

As shown in FIG. 8A, a peripheral area 1 of the near point image is in focus, and a center area 2 of the near point image is out of focus. Conversely, as shown in FIG. 8B, a peripheral area 1 of the far point image is out of focus, and a center area 2 of the far point image is in focus. The area 1 is an area corresponding to the depth of field DF1 shown in FIG. 7 where the object is positioned close to the imaging section. The area 2 is an area corresponding to the depth of field DF2 shown in FIG. 7 where the object is positioned away from the imaging section.

The exposure of the first imaging element 250 that acquires the near point image is half (α=0.5) of the exposure of the second imaging element 260 that acquires the far point image, as described above. Therefore, the exposure of the near point image is relatively smaller than that of the far point image, so that appropriate brightness is obtained in the peripheral area 1 of the near point image, and the center area 2 of the near point image shows blocked up shadows due to insufficient exposure (see FIG. 8A). On the other hand, as shown in FIG. 8B, since the exposure of the far point image is relatively larger than that of the near point image, the peripheral area 1 of the far point image shows blown out highlights clue to too large an exposure, and appropriate brightness is obtained in the center area 2 of the far point image.

Therefore, appropriate brightness is obtained over the entire image (see FIG. 8C) by synthesizing the in-focus area of the near point image and the in-focus area of the far point image. A synthetic image with an increased depth of field and an increased dynamic range can thus be generated.

A first modification of the synthetic image pixel value calculation method is described below. When the object successively changes from a position close to the imaging section to a position away from the imaging section (see FIG. 7), a discontinuous change in brightness may occur in the synthetic image at or around the depth-of-field boundary (X) (i.e., the boundary between the area 1 and the area 2 of the synthetic image). In this case, the pixel value determination section 632 may calculate the pixel values of the synthetic image using the sharpness S_In(x, y) and S_If(x, y) of the near point image and the far point image according to the following expression (2), for example.

Ic(x, y)=[S_In(x, y)*In(x, y)+S_If(x, y)*If(x, y)]/[S_In(x, y)+S_If(x, y)] (2)

This makes it possible to continuously change the brightness of the synthetic image at or around the depth-of-field boundary. The depth-of-field boundary is the boundary between the in-focus area and the out-of-focus area where the resolution of the near point image and the resolution of the far point image are almost equal. Therefore, a deterioration in resolution occurs to only a small extent even if the pixel values of the synthetic image are calculated while weighting the pixel values using the sharpness (see expression (2)).

A second modification of the synthetic image pixel value calculation method is described below. In the second modification, the difference |S_In(x, y)−S_If(x, y)| in sharpness between the near point image and the far point image is compared with a threshold value S_th. When the difference |S_In(x, y)−S_If(x, y)| is equal to or larger than the threshold value S_th, the pixel value of the image having higher sharpness is selected as the pixel value of the synthetic image (see expression (1)). When the difference |S_In(x, y)−S_If(x, y)| is smaller than the threshold value S_th, the pixel value of the synthetic image is calculated by the expression (2) or the following expression (3).

Ic(x, y)=[In(x, y)+If(x, y)]/2 (3)

Although the above embodiments have been described taking the endoscope system as an example, the above embodiments are not limited thereto. For example, the above embodiments may also be applied to an imaging apparatus (e.g., still camera) that captures an image using an illumination device such as a flash.

In order to improve the visibility of an object positioned at an arbitrary distance from the imaging section (e.g., an object positioned close to the imaging section and an object positioned away from the imaging section), it is necessary to increase the dynamic range (i.e., a range in which correct exposure can be obtained), and increase the depth of field (i.e., a range in which the object is brought into focus).

As shown in FIGS. 1 and 4, the above imaging apparatus includes the image acquisition section 610, the exposure adjustment section 240, and the synthetic image generation section 630. The image acquisition section 610 acquires a near point image in which a near-point object is in focus, and a far point image in which a far-point object positioned away as compared with the near-point object is in focus. The exposure adjustment section 240 adjusts the ratio a of the exposure of the near point image to the exposure of the far point image. The synthetic image generation section 630 selects a first area (area 1) that is an in-focus area in the near point image and a second area (area 2) that is an in-focus area in the far point image to generate a synthetic image. The synthetic image generation section 630 generates the synthetic image based on the near point image and the far point image acquired with exposure for which the ratio α is adjusted.

This makes it possible to acquire an image with an increased depth of field and an increased dynamic range. Specifically, the exposure of the in-focus area 1 of the near point image and the exposure of the in-focus area 2 of the far point image can be appropriately adjusted by adjusting the ratio α as described with reference to FIGS. 8A to 8C. This makes it possible to acquire an image in which the near-point object and the far-point object are in focus with correct exposure.

The term “near-point object” used herein refers to an object positioned within the depth of field DF1 of the imaging element that is positioned at the distance Zn′ from the back focal distance of the objective lens (see FIG. 3A). The term “far-point object” used herein refers to an object positioned within the depth of field DF2 of the imaging element that is positioned at the distance Zf′ from the back focal distance of the objective lens (see FIG. 3B).

The exposure adjustment section 240 brings the exposure of the first area (area 1) that is an in-focus area in the near point image and exposure of the second area (area 2) that is an in-focus area in the far point image close to each other by adjusting the ratio α (see FIGS. 8A to 8C). The synthetic image generation section 630 synthesizes the in-focus first area of the near point image and the in-focus second area of the far point image to generate a synthetic image.

Therefore, the exposure within the depth of field DF1 and the exposure within the depth of field DF2 (i.e., brightness differs depending on the distance from the imaging section 200) (see FIG. 7) can be brought close to each other by adjusting the ratio α. This makes it possible to implement a more correct exposure state within the depth of field DF1 (area 1) in the near point image and the depth of field DF2 (area 2) in the far point image.

The exposure adjustment section 240 reduces the exposure of the near point image by adjusting the ratio α of the exposure of the near point image to the exposure of the far point image to a value equal to or smaller than a given reference value so that the exposure of the first area (area 1) that is an in-focus area in the near point image and the exposure of the second area (area 2) that is an in-focus area in the far point image are brought close to each other.

For example, the ratio α is set to a value equal to or smaller than 1 (i.e., given reference value) in order to reduce the exposure of the near point image. Specifically, the given reference value is a value that ensures that the exposure of the near point image is smaller than the exposure of the far point image when the brightness of illumination light decreases as the distance from the imaging section increases.

This makes it possible to reduce the exposure of the area 1 of the near point image that is positioned close to the imaging section and illuminated brightly to a value close to the exposure of the area 2 of the far point image (see FIGS. 8A to 8C).

As shown in FIG. 1, the exposure adjustment section 240 includes the division section (e.g., half mirror). The division section divides reflected light from the object obtained by applying illumination light to the object into first reflected light RL1 corresponding to the near point image and second reflected light RL2 corresponding to the far point image. The division section divides the intensity of the second reflected light RL2 relative to the intensity of the first reflected light RL1 by the ratio α. The division section emits the first reflected light RL1 to the first imaging element 250 disposed at a first distance D1 from the division section, and emits the second reflected light RL2 to the second imaging element 260 disposed at a second distance D2 from the division section, the second distance D2 differing from the first distance D1. The image acquisition section 610 acquires the near point image captured by the first imaging element 250 and the far point image captured by the second imaging element 260.

Therefore, the exposure ratio α can be adjusted by dividing the intensity of the second reflected light RL2 relative to the intensity of the first reflected light RL1 by the ratio α. The near point image and the far point image that differ in exposure and depth of field can be acquired by emitting the first reflected light RL1 to the first imaging element 250, and emitting the second reflected light RL2 to the second imaging element 260.

Each of the distances D1 and D2 is the distance from the reflection surface (or the transmission surface) of the division section to the imaging element along the optical axis of the imaging optical system. Each of the distances D1 and D2 corresponds to the distance from the reflection surface of the division section to the imaging element when the distance from the back focal distance of the objective lens 230 to the imaging element is Zn′ or Zf′ (see FIGS. 3A and 3B).

As shown in FIG. 5, the synthetic image generation section 630 includes the sharpness calculation section 631 and the pixel value determination section 632. The sharpness calculation section 631 calculates the sharpness S_In(x, y) and S_If(x,y) of the processing target pixels In(x, y) and If(x, y) of the near point image and the far point image. The pixel value determination section 632 determines the pixel value Ic(x, y) of the processing target pixel of the synthetic image based on the sharpness S_In(x, y) and S_If(x, y), the pixel value In(x, y) of the near point image, and the pixel value If(x, y) of the far point image.

More specifically, the pixel value determination section 632 determines the pixel value In(x, y) of the processing target pixel of the near point image to be the pixel value Ic(x, y) of the processing target pixel of the synthetic image when the sharpness S_In(x, y) of the processing target pixel of the near point image is higher than the sharpness S_If(x, y) of the processing target pixel of the far point image (see expression (1)). The pixel value determination section 632 determines the pixel value If(x, y) of the processing target pixel of the far point image to be the pixel value Ic(x, y) of the processing target pixel of the synthetic image when the sharpness S_if(x, y) of the processing target pixel of the far point image is higher than the sharpness S_In(x, y) of the processing target pixel of the near point image.

The in-focus area of the near point image and the far point image can be synthesized by utilizing the sharpness. Specifically, the in-focus area can be determined and synthesized by selecting the processing target pixel having higher sharpness.

The pixel value determination section 632 may calculate the weighted average of the pixel value In(x, y) of the processing target pixel of the near point image and the pixel value If(x, y) of the processing target pixel of the fax point image based on the sharpness S_In(x, y) and S_If(x, y) to calculate the pixel value Ic(x, y) of the processing target pixel of the synthetic image (see expression (2)).

The brightness of the synthetic image can be changed smoothly at the boundary between the in-focus area of the near point image and the in-focus area of the far point image by calculating the weighted average of the pixel values based on the sharpness.

The pixel value determination section 632 may average the pixel value In(x, y) of the processing target pixel of the near point image and the pixel value If(x, y) of the processing target pixel of the far point image to calculate the pixel value Ic(x, y) of the processing target pixel of the synthetic image when the difference |S_In(x,y)−S_If(x,y)| (absolute value) between the sharpness of the processing target pixel of the near point image and the sharpness of the processing target pixel of the far point image is smaller than the threshold value S_th (see expression (3)).

The boundary between the in-focus area of the near point image and the in-focus area of the far point image can be determined by determining an area where the difference |S_In(x,y)−S_If(x,y)| is smaller than the threshold value S_th. The brightness of the synthetic image can be changed smoothly by averaging the pixel values at the boundary between the in-focus area of the near point image and the in-focus area of the far point image.

The exposure adjustment section 240 adjusts the exposure using the constant ratio α (e.g., 0.5). More specifically, the exposure adjustment section 240 includes at least one beam splitter that divides reflected light from the object obtained by applying illumination light to the object into the first reflected light RL1 and the second reflected light RL2 (see FIG. 1). The at least one beam splitter divides the intensity of the first reflected light RL1 relative to the intensity of the second reflected light RL2 by the constant ratio α (e.g., 0.5).

This makes it possible to adjust the ratio of the exposure of the near point image to the exposure of the far point image to the constant ratio α. Specifically, the exposure ratio can be set to the constant ratio α by adjusting the incident intensity ratio of the first imaging element 250 and the second imaging element 260 to the constant ratio α. Note that the reflected light may be divided using one beam splitter, or may be divided using two or more beam splitters.

### 5. Second Configuration Example of Endoscope System

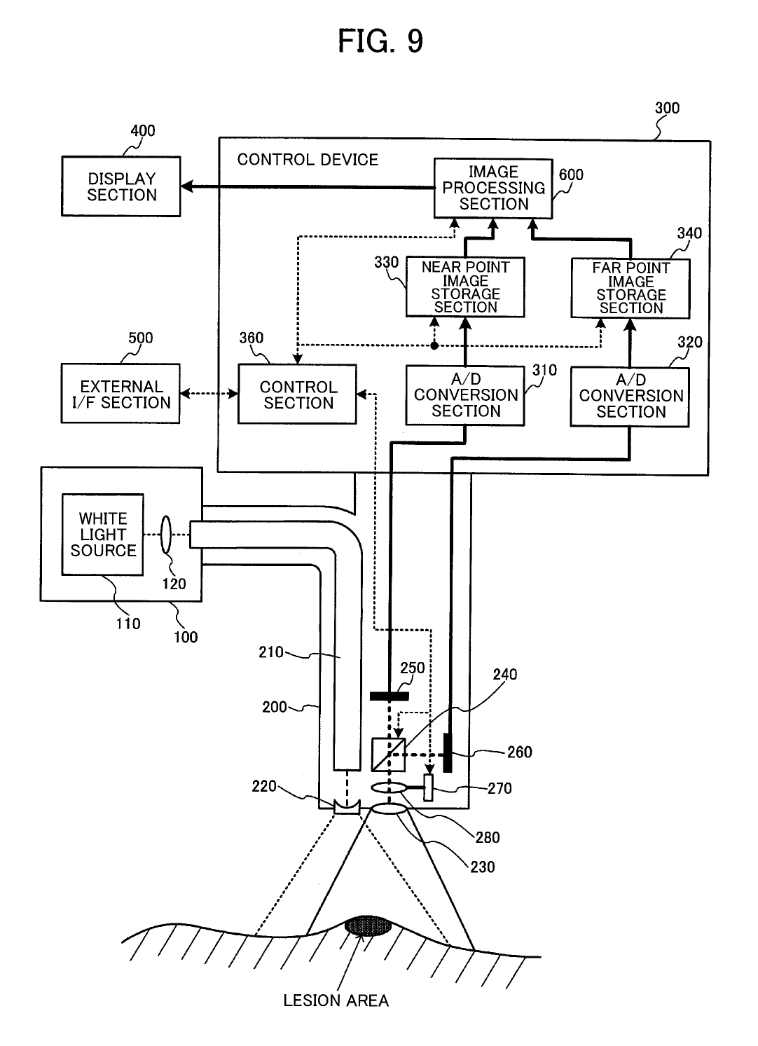

The above embodiments have been described taking an example in which the exposure is adjusted using the constant ratio α. Note that the exposure may be adjusted using a variable ratio α. FIG. 9 shows a second configuration example of an endoscope system employed when using a variable ratio α. The endoscope system shown in FIG. 9 includes a light source section 100, an imaging section 200, a control device 300, a display section 400, and an external I/F section 500. Note that the details of the first configuration example may be applied to the second configuration example unless otherwise specified.

The imaging section 200 includes a light guide fiber 210 that guides light focused by the light source section, an illumination lens 220 that diffuses light that has been guided by the light guide fiber 210, and illuminates an object, and an objective lens 230 that focuses light reflected by the object. The imaging section 200 also includes a zoom lens 280 used to switch an observation mode between a normal observation mode and a magnifying observation mode, a lens driver section 270 that drives the zoom lens 280, an exposure adjustment section 240 that divides the focused reflected light, a first imaging element 250, and a second imaging element 260.

The lens driver section 270 includes a stepping motor or the like, and drives the zoom lens 280 based on a control signal from the control section 360. For example, the endoscope system is configured so that the position of the zoom lens 280 is controlled based on observation mode information input by the user using the external I/F section 500 so that the observation mode is switched between the normal observation mode and the magnifying observation mode.

Note that the observation mode information is information that is used to set the observation mode, and corresponds to the normal observation mode or the magnifying observation mode, for example. The observation mode information may be information about the in-focus object plane that is adjusted using a focus adjustment knob. For example, the observation mode is set to the low-magnification normal observation mode when the in-focus object plane is furthest from the imaging section within a focus adjustment range. The observation mode is set to the high-magnification magnifying observation mode when the in-focus object plane is closer to the imaging section than the in-focus object plane in the normal observation mode.

The exposure adjustment section 240 is a switchable mirror made of a magnesium-nickel alloy thin film, for example. The exposure adjustment section 240 arbitrarily changes the ratio α of the exposure of the first imaging element 250 to the exposure of the second imaging element 260 based on a control signal from the control section 360. For example, the endoscope system is configured so that the ratio α is controlled based on the observation mode information input by the user using the external I/F section 500.

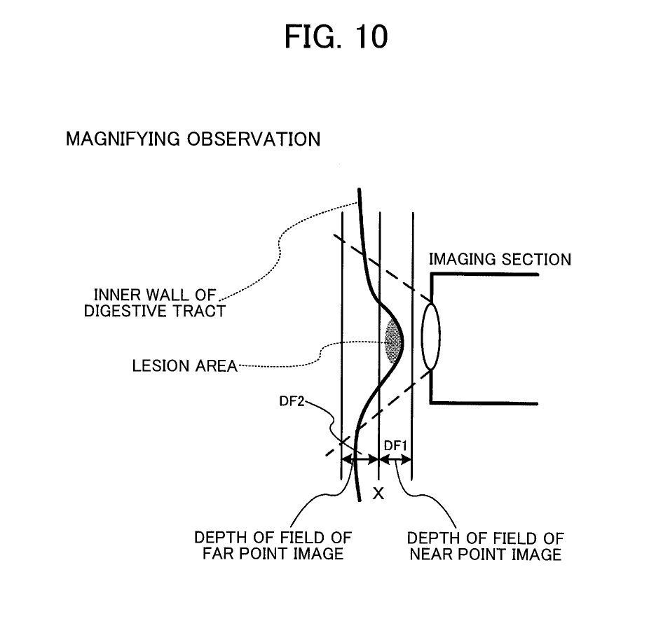

A synthetic image generated by the pixel value determination section 632 is described below with reference to FIGS. 10 to 12C. FIG. 10 shows a digestive tract magnifying observation state when using the endoscope system according to the second configuration example. In the magnifying observation mode of the endoscope system, the angle of view of the objective lens decreases as compared with the normal observation mode due to by the optical design, and the depth of field of the near point image and the depth of field of the far point image are very narrow as compared with the normal observation mode. Therefore, a lesion area is closely observed in the magnifying observation mode in a state in which the endoscope directly confronts the inner wall of the digestive tract (see FIG. 10), and a change in distance from the imaging section to the object within the angle of view may be very small. Therefore, the brightness within the near point image and the far point image is almost constant irrespective of the position within the image.

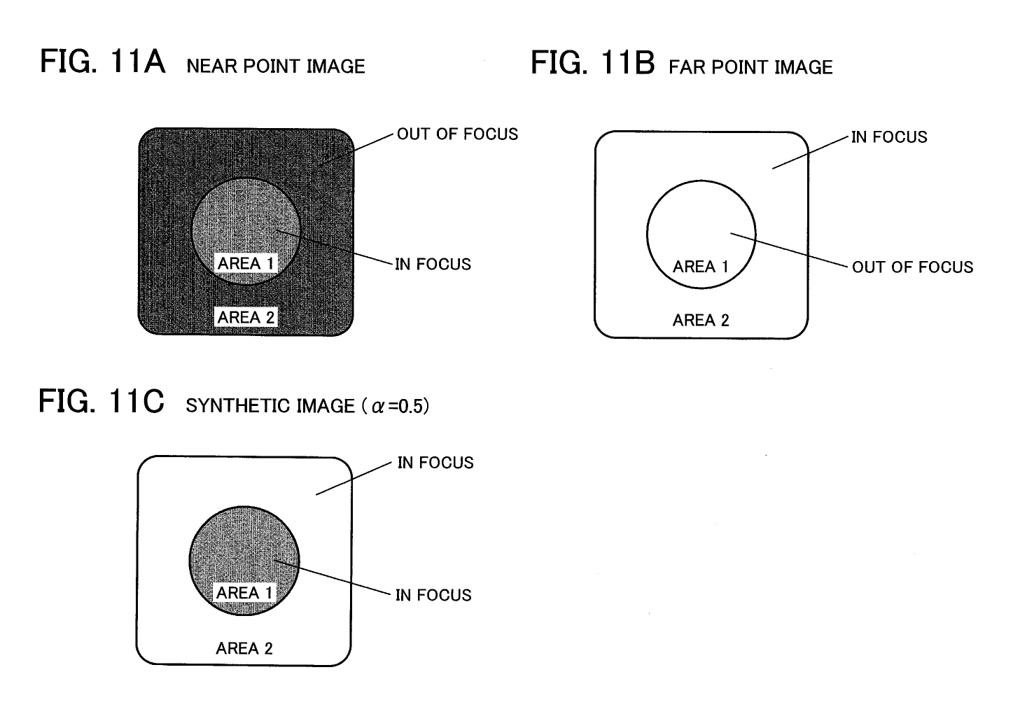

FIGS. 11A and 11B schematically show a near point image and a far point image acquired in the magnifying observation state when the ratio α of the exposure of the first imaging element 250 to the exposure of the second imaging element 260 is set to 0.5. As shown in FIG. 11A, a center area 1 of the near point image is in focus, and a peripheral area 2 of the near point image is out of focus. Conversely, as shown in FIG. 11B, a center area 1 of the far point image is out of focus, and a peripheral area 2 of the far point image is in focus. The area 1 is an area corresponding to the depth of field DF1 shown in FIG. 10 where the object is positioned relatively close to the imaging section. The area 2 is an area corresponding to the depth of field DF2 shown in FIG. 10 where the object is positioned relatively away from the imaging section.

If appropriate brightness is obtained in the near point image acquired when the ratio α is set to 0.5, the entire far point image shows blown out highlights (see FIG. 11B) since the exposure of the far point image is twice the exposure of the near point image. Therefore, when synthesizing the in-focus area of the near point image and the in-focus area of the far point image, appropriate brightness is obtained in the center area of the image, but the peripheral area of the image shows blown out highlights (see FIG. 11C).

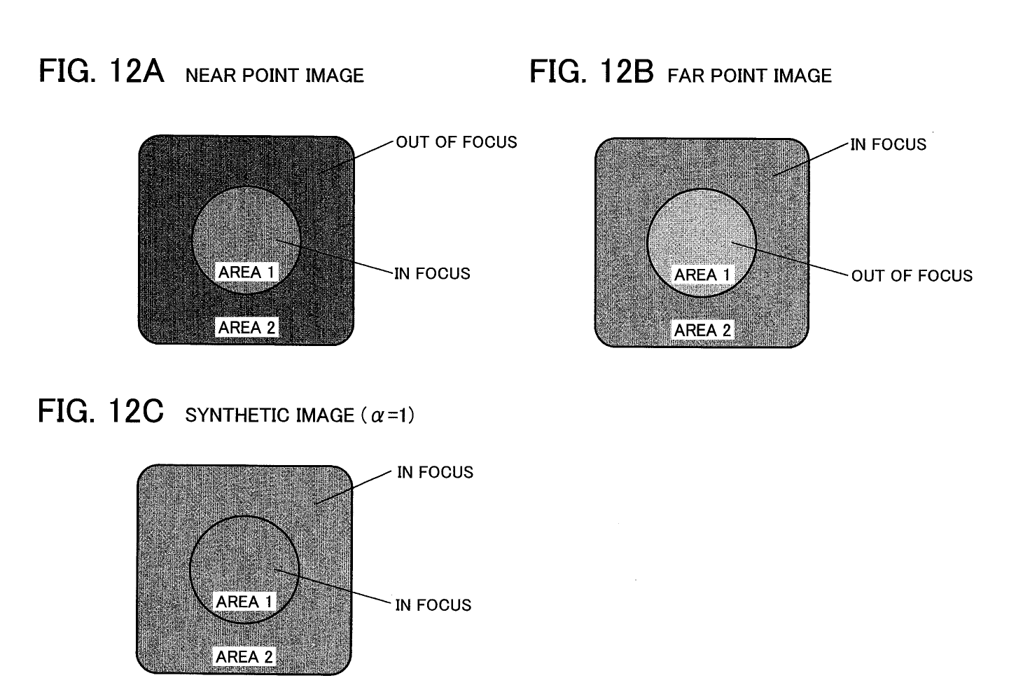

In order to prevent such a phenomenon, the endoscope system according to the second configuration example is configured so that the ratio α of the exposure of the first imaging element 250 to the exposure of the second imaging element 260, and the position of the zoom lens 280 are controlled based on the observation mode information input by the user using the external I/F section 500. For example, the ratio α is set to 0.5 in the normal observation mode, and is set to 1 in the magnifying observation mode. As shown in FIG. 12B, correct exposure is obtained in the near point image and the far point image when the ratio α is set to 1. Therefore, a synthetic image having appropriate brightness over the entire image is generated (see FIG. 12C).

Note that the ratio α is not limited to 0.5 or 1, but may be set to an arbitrary value.

Note that the exposure adjustment section 240 is not limited to the switchable mirror. For example, the reflected light from the object may be divided using abeam splitter instead of the switchable mirror so that the ratio α is 1, and the ratio α may be arbitrarily changed by inserting an intensity adjustment member (e.g., a liquid crystal shutter having a variable transmission, or a variable aperture having a variable inner diameter) into the optical path between the beam splitter and the first imaging element 250. Note that the intensity adjustment member may be inserted into the optical path between the beam splitter and the first imaging element 250 and the optical path between the beam splitter and the second imaging element 260.

Although the above embodiments have been described taking an example in which one of two values is selected as the ratio α when switching the observation mode between the normal observation mode and the magnifying observation mode, another control method may also be employed. For example, when the position of the zoom lens 280 successively changes, the ratio α may be successively changed depending on the position of the zoom lens 280.

Although the above embodiments have been described taking an example in which the position of the zoom lens 280 and the ratio α are controlled at the same time, the magnifying observation function (zoom lens 280 and driver section 270) is not necessarily indispensable. For example, a tubular object observation mode, a planar object observation mode, and the like may be set, and only the ratio α may be controlled depending on the shape of the object. Alternatively, the average luminance Yn of pixels included in the in-focus area of the near point image, and the average luminance Yf of pixels included in the in-focus area of the far point image may be calculated, and the ratio α may be controlled so that the difference between the average luminance Yn and the average luminance Yf decreases when the difference between the average luminance Yn and the average luminance Yf is equal to or larger than a given threshold value.

According to the second configuration example, the exposure adjustment section 240 adjusts the exposure using the variable ratio α (see FIG. 9). Specifically, the exposure adjustment section 240 adjusts the ratio α corresponding to the observation state. For example, the observation state is set corresponding to the in-focus object plane position of the near point image and the far point image, and the exposure adjustment section 240 adjusts the ratio α corresponding to the in-focus object plane position. Specifically, the exposure adjustment section 240 sets the ratio α to a first ratio (e.g., 0.5) in the normal observation state. And the exposure adjustment section 240 sets the ratio α to a second ratio (e.g., 1) that is larger than the first ratio in the magnifying observation state in which the in-focus object plane position is shorter than the in-focus object plane position in the normal observation state.

The term “observation state” refers to an imaging state when observing the object (e.g., the relative positional relationship between the imaging section and the object). The endoscope system according to the second configuration example has a normal observation state in which the endoscope system captures the inner wall of the digestive tract in the direction along the digestive tract (see FIG. 7), and a magnifying observation state in which the endoscope system captures the inner wall of the digestive tract in a state in which the endoscope system directly confronts the inner wall of the digestive tract (see FIG. 10). Since the object is normally observed in the normal observation state and the magnifying observation state in each of the normal observation mode and the magnifying observation mode that are set corresponding to the in-focus object plane, the ratio α is adjusted corresponding to the observation mode.

This makes it possible to appropriately adjust the exposure adjustment corresponding to the observation state. Specifically, the difference in distance from the imaging section is small between the near-point object and the far-point object in the magnifying observation state as compared with the normal observation state (see FIGS. 11A to 12C). Therefore, correct exposure can be implemented by increasing the second ratio even in the magnifying observation state in which the near-point object and the far-point object are illuminated at almost the same intensity.

The exposure adjustment section 240 may adjust the ratio α so that the difference between the average luminance of the in-focus area of the near point image and the average luminance of the in-focus area of the far point image decreases.

In this case, even if the luminance of illumination light applied to the near-point object and the far-point object changes corresponding to the observation state, the exposure of the near-point object and the exposure of the far-point object can be brought close to each other by automatically controlling the ratio α based on the average luminance.

As shown in FIG. 9, the exposure adjustment section 240 includes at least one adjustable transmittance mirror that divides reflected light from the object obtained by applying illumination light to the object into the first reflected light and the second reflected light. The at least one adjustable transmittance mirror divides the intensity of the first reflected light relative to the second reflected light by the variable ratio α. Note that the reflected light may be divided using one switchable mirror, or may be divided using two or more switchable mirrors.

Alternatively, the exposure adjustment section 240 may include a division section that divides reflected light from the object obtained by applying illumination light to the object into first reflected light and second reflected light, and at least one variable aperture that adjusts the intensity of the first reflected light relative to the second reflected light to the variable ratio α. Note that the intensity of reflected light may be adjusted using one variable aperture, or may be adjusted using two or more variable apertures.

The exposure adjustment section 240 may include a division section that divides reflected light from the object obtained by applying illumination light to the object into first reflected light and second reflected light, and at least one liquid crystal shutter that adjusts the intensity of the first reflected light relative to the second reflected light to the variable ratio α. Note that the reflected light may be divided using one liquid crystal shutter, or may be divided using two or more liquid crystal shutters.

This makes it possible to adjust the exposure using the variable ratio α. Specifically, the ratio α can be made variable by adjusting the intensity of the first reflected light using a switchable mirror, a variable aperture, or a liquid crystal shutter.

Although the above embodiments have been described taking an example in which a synthetic image is generated using the near point image and the far point image in the normal observation state and the magnifying observation state, the above embodiments are not limited thereto. For example, a synthetic image may be generated using the near point image and the far point image in the normal observation state, and the near point image may be directly output in the magnifying observation state without performing the synthesis process.

### 6. Third Configuration Example of Endoscope System

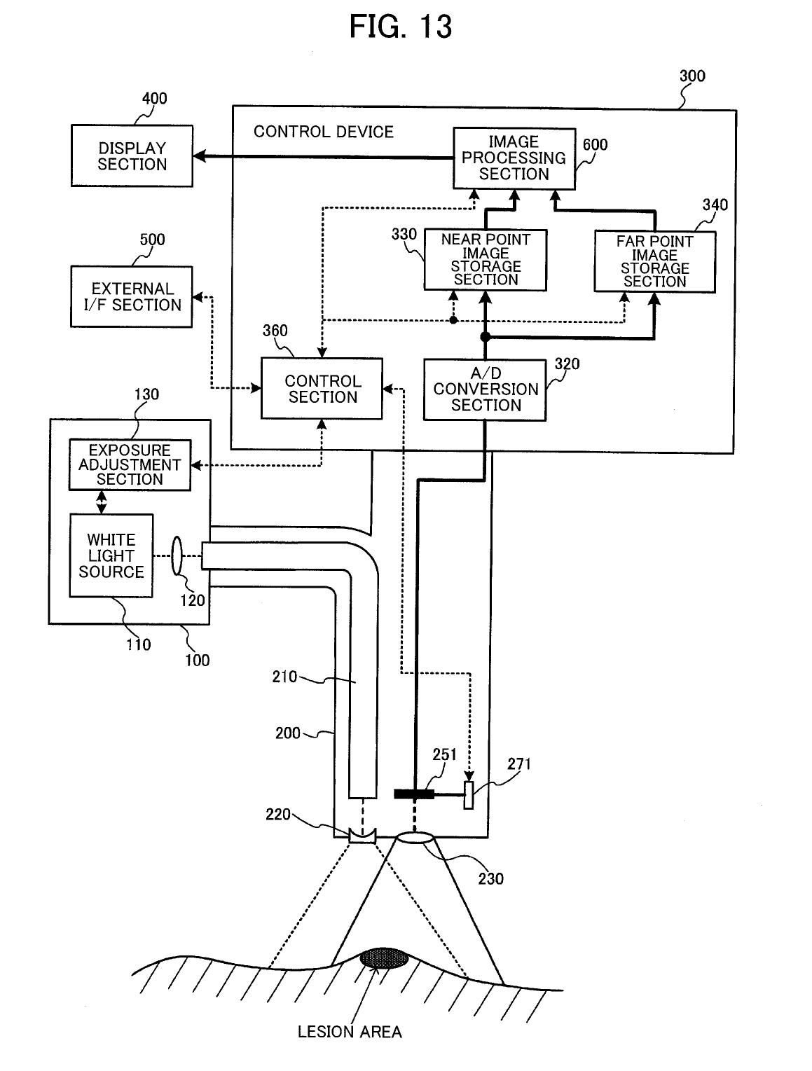

Although the above embodiments have been described taking an example in which the near point image and the far point image are captured using two imaging elements, the near point image and the far point image may be captured by time division using a single imaging element. FIG. 13 shows a third configuration example of an endoscope system employed when capturing the near point image and the far point image by time division using a single imaging element. The endoscope system shown in FIG, 13 includes a light source section 100, an imaging section 200, a control device 300, a display section 400, and an external I/F section 500. Note that the details of the first configuration example may be applied to the third configuration example unless otherwise specified.

The light source section 100 emits illumination light to an object. The light source section 100 includes a white light source 110 that emits white light, a condenser lens 120 that focuses the white light on a light guide fiber 210, and an exposure adjustment section 130.

The white light source 110 is an LED light source or the like. The exposure adjustment section 130 adjusts the ratio α of the exposure of the near point image to the exposure of the far point image by controlling the exposure of the image by time division. For example, the exposure adjustment section 130 adjusts the exposure of the image by controlling the emission time of the white light source 110 based on a control signal from the control section 360.

The imaging section 200 includes a light guide fiber 210 that guides light focused by the light source section, an illumination lens 220 that diffuses light that has been guided by the light guide fiber 210, and illuminates an object, and an objective lens 230 that focuses light reflected by the object. The imaging section 200 includes an imaging element 251 and a focus adjustment section 271.

The focus adjustment section 271 adjusts the in-focus object plane of an image by time division. A near point image and a far point image that differ in in-focus object plane are captured by adjusting the in-focus object plane by time division. The focus adjustment section 271 includes a stepping motor or the like, and adjusts the in-focus object plane of the acquired image by controlling the position of the imaging element 251 based on a control signal from the control section 360.

The control device 300 (processing section) controls each element of the endoscope system. The control device 300 includes an A/D conversion section 320, a near point image storage section 330, a far point image storage section 340, an image processing section 600, and a control section 360.

The A/D conversion section 320 converts an analog signal output from the imaging element 250 into a digital signal, and outputs the digital signal. The near point image storage section 330 stores an image acquired at a first timing as a near point image based on a control signal from the control section 360. The far point image storage section 340 stores an image acquired at a second timing as a far point image based on a control signal from the control section 360. The image processing section 600 synthesizes the in-focus area of the near point image and the in-focus area of the far point image in the same manner as in the first configuration example and the like to generate a synthetic image with an increased depth of field and an increased dynamic range.

The relationship between the image acquisition timing and the depth of field is described below with reference to FIGS. 3A and 3B. As shown in FIG. 3A, the focus adjustment section 271 controls the position of the imaging element 251 at the first timing on that the distance from the back focal distance to the imaging element 251 is Zn′. As shown in FIG. 3B, the focus adjustment section 271 controls the position of the imaging element 251 at the second timing so that the distance from the back focal distance to the imaging element 251 is Zf′. Therefore, the depth of field of the image acquired at the first timing is close to the objective lens as compared with the depth of field of the image acquired at the second timing. Specifically, a near point image is acquired at the first timing, and a far point image is acquired at the second timing.

The relationship between the image acquisition timing and the exposure is described below. The exposure adjustment section 130 sets the emission time of the white light source 110 at the first timing to a value 0.5 times the emission time of the white light source 110 at the second timing, for example. The exposure adjustment section 130 thus adjusts the ratio α of the exposure of the near point image acquired at the first timing to the exposure of the far point image acquired at the second timing to 0.5.

Therefore, the near point image acquired at the first timing and the far point image acquired at the second timing are similar to the near point image acquired by the first imaging element 250 and the far point image acquired by the second imaging element 260 in the first configuration example. A synthetic image with an increased depth of field and an increased dynamic range can be generated by synthesizing the near point image and the far point image.

Although the above embodiments have been described taking an example in which the focus adjustment section 271 adjusts the in-focus object plane of the image by controlling the position of the imaging element 251, the above embodiments are not limited thereto. For example, the objective lens 230 may include an in-focus object plane adjustment lens, and the focus adjustment section 271 may adjust the in-focus object plane of the image by controlling the position of the in-focus object plane adjustment lens instead of the position of the imaging element 251.

Although the above embodiments have been described taking an example in which the ratio α is net to 0.5, the ratio α may be set to an arbitrary value. Although the above embodiments have been described taking an example in which the ratio α is controlled by adjusting the emission time of the white light source 110, the above embodiments are not limited thereto. For example, the exposure adjustment section 130 may set the ratio α to 0.5 by setting the intensity of the white light source 110 at the first timing to a value 0.5 times the intensity of the white light source 110 at the second timing.

### 7. Second Specific Configuration Example of Synthetic Image Generation Section

In the third configuration example, the near point image and the far point image are acquired at different timings. Therefore, the position of the object within the image differs between the near point image and the far point image when the object or the imaging section 200 moves, so that an inconsistent synthetic image is generated. In this case, a motion compensation process may be performed on the near point image and the far point image.

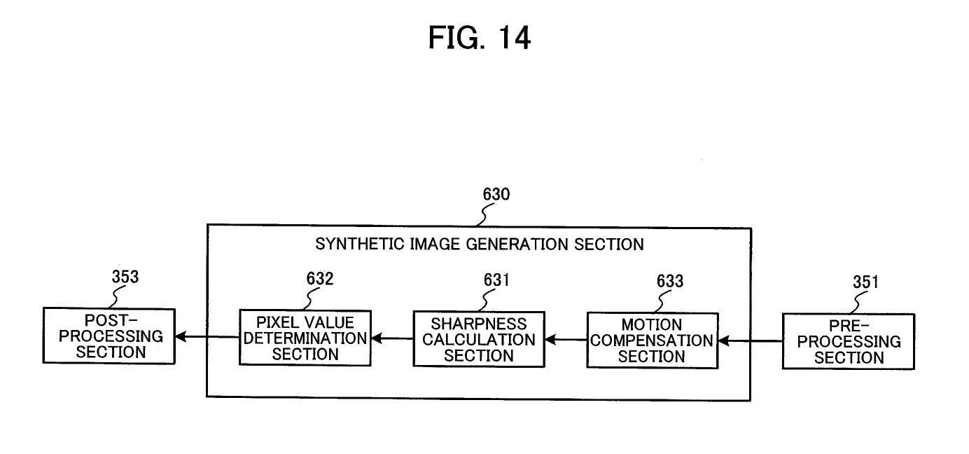

FIG. 14 shows a specific configuration example of the synthetic image generation section 630 when the synthetic image generation section 630 performs the motion compensation process. The synthetic image generation section 630 shown in FIG. 14 includes a motion compensation section 633 (positioning section), the sharpness calculation section 631, and the pixel value determination section 632.

The motion compensation section 633 performs the motion compensation process on the near point image and the far point image output from the preprocessing section 620 using known motion compensation (positioning) technology, for example. For example, a matching process such as SSD (sum of squared difference) may be used as the motion compensation process. The sharpness calculation section 631 and the pixel value determination section 632 generate a synthetic image from the near point image and the far point image subjected to the motion compensation process.

It may be difficult to perform the matching process since the near point image and the far point image differ in in-focus area. In this case, a reduction process is performed (e.g., signal values corresponding to 2×2 pixels that are adjacent in the horizontal direction and the vertical direction are added) on the near point image and the far point image. The matching process may be performed after thus reducing the difference in resolution between the near point image and the far point image of the same object by the reduction process.

According to the above embodiments, the imaging apparatus includes the focus control section that controls the in-focus object plane position. As shown in FIGS. 3A and 3B, the image acquisition section 610 acquires an image captured at the first timing at which the in-focus object plane position is set to the first in-focus object plane position Pn as the near point image, and acquires an image captured at the second timing at which the in-focus object plane position is set to the second in-focus object plane position Pf as the far point image, the second in-focus object plane position Pf differs from the first in-focus object plane position Pn. For example, the focus adjustment section 271 adjusts the in-focus object plane position by moving the position of the imaging element 251 (driving the imaging element 251) under control of the control section 360 (see FIG. 13).

The exposure adjustment section 130 adjusts the ratio α of the exposure of the near point image to the exposure of the far point image by causing the intensity of illumination light that illuminates the object to differ between the first timing and the second timing.

Therefore, since the depth of field and the exposure are changed by time division, a near point image and a far point image that differ in depth of field and exposure can be captured by time division. This makes it possible to generate a synthetic image with an increased depth of field and an increased dynamic range.

As shown in FIGS. 3A and 3B, the in-focus object plane refers to the distance Pn or Pf from the objective lens 230 to the object when the object is in focus. The in-focus object plane Pn or Pf is determined by the distances Zn′ or Zf′, the focal length of the objective lens 230, and the like.

As shown in FIG. 14, the synthetic image generation section 630 may include the motion compensation section 633 that performs the motion compensation process on the near point image and the far point image. The synthetic image generation section 630 may generate a synthetic image based on the near point image and the far point image subjected to the motion compensation process.

This makes it possible to adjust the position of the object in the near point image and the far point image even if the near point image and the far point image acquired by time division differ in the position of the object due to the motion of the digestive tract or the like. This makes it possible to suppress distortion of the object in the synthetic image, for example.

The embodiments according to the invention and modifications thereof have been described above. Note that the invention is not limited to the above embodiments and modifications thereof. Various modifications and variations may be made without departing from the scope of the invention. A plurality of elements of the above embodiments and modifications thereof may be appropriately combined. For example, some of the elements of the above embodiments and modifications thereof may be omitted. Some of the elements described in connection with the above embodiments and modifications thereof may be appropriately combined. Specifically, various modifications and applications are possible without materially departing from the novel teachings and advantages of the invention.

Any term (e.g., endoscope apparatus, control device, or beam splitter) cited with a different term (e.g., endoscope system, processing section, or division section) having a broader meaning or the same meaning at least once in the specification and the drawings may be replaced by the different term in any place in the specification and the drawings.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. An imaging apparatus comprising:
an image acquisition section that acquires a near point image in which a near-point object is in focus, and a far point image in which a far-point object is in focus, the far-point object being positioned away as compared with the near-point object;
an exposure adjustment section that adjusts a ratio of exposure of the near point image to exposure of the far point image; and
a synthetic image generation section that selects a first area that is an in-focus area in the near point image and a second area that is an in-focus area in the far point image to generate a synthetic image,
the synthetic image generation section generating the synthetic image based on the near point image and the far point image acquired with exposure for which the ratio is adjusted.

2. The imaging apparatus as defined in claim 1,
the exposure adjustment section bringing exposure of the first area that is an in-focus area in the near point image and exposure of the second area that is an in-focus area in the far point image close to each other by adjusting the ratio.

3. The imaging apparatus as defined in claim 2,
the exposure adjustment section reducing the exposure of the near point image by adjusting the ratio of the exposure of the near point image to the exposure of the far point image to a value equal to or smaller than a given reference value so that the exposure of the first area that is an in-focus area in the near point image and the exposure of the second area that is an in-focus area in the far point image are brought close to each other.

4. The imaging apparatus as defined in claim 3,
the exposure adjustment section including a division section that divides reflected light from an object obtained by applying illumination light to the object into first reflected light corresponding to the near point image and second reflected light corresponding to the far point image,
the division section dividing intensity of the second reflected light relative to intensity of the first reflected light by the ratio, emitting the first reflected light to a first imaging element disposed at a first distance from the division section, and emitting the second reflected light to a second imaging element disposed at a second distance from the division section, the second distance differing from the first distance, and
the image acquisition section acquiring the near point image captured by the first imaging element and the far point image captured by the second imaging element.

5. The imaging apparatus as defined in claim 1,
the synthetic image generation section including a sharpness calculation section that calculates sharpness of a processing target pixel of each of the near point image and the far point image, and a pixel value determination section that determines a pixel value of the processing target pixel of the synthetic image based on the sharpness, a pixel value of the near point image, and a pixel value of the far point image.

6. The imaging apparatus as defined in claim 5,
the pixel value determination section determining the pixel value of the processing target pixel of the near point image to be the pixel value of the processing target pixel of the synthetic image when the sharpness of the processing target pixel of the near point image is higher than the sharpness of the processing target pixel of the far point image, and
the pixel value determination section determining the pixel value of the processing target pixel of the far point image to be the pixel value of the processing target pixel of the synthetic image when the sharpness of the processing target pixel of the far point image is higher than the sharpness of the processing target pixel of the near point image.

7. The imaging apparatus as defined in claim 5,
the pixel value determination section calculating a weighted average of the pixel value of the processing target pixel of the near point image and the pixel value of the processing target pixel of the far point image based on the sharpness to calculate the pixel value of the processing target pixel of the synthetic image.

8. The imaging apparatus as defined in claim 5,
the pixel value determination section averaging the pixel value of the processing target pixel of the near point image and the pixel value of the processing target pixel of the far point image to calculate the pixel value of the processing target pixel of the synthetic image when an absolute value of a difference between the sharpness of the processing target pixel of the near point image and the sharpness of the processing target pixel of the far point image is smaller than a threshold value.

9. The imaging apparatus as defined in claim 1,
the exposure adjustment section including a division section that divides reflected light from an object obtained by applying illumination light to the object, and
the image acquisition section acquiring the near point image captured by a first imaging element disposed at a first distance from the division section, and acquiring the far point image captured by a second imaging element disposed at a second distance from the division section, the second distance differing from the first distance.

10. The imaging apparatus as defined in claim 1,
the exposure adjustment section adjusting the exposure using the ratio that is constant.

11. The imaging apparatus as defined in claim 10,
the exposure adjustment section including at least one beam splitter that divides reflected light from an object obtained by applying illumination light to the object into first reflected light and second reflected light, and
the at least one beam splitter dividing intensity of the first reflected light relative to intensity of the second reflected light by the constant ratio.

12. The imaging apparatus as defined in claim 1,
the exposure adjustment section adjusting the exposure using the ratio that is variable.

13. The imaging apparatus as defined in claim 12,
the exposure adjustment section adjusting the ratio corresponding to an observation state.

14. The imaging apparatus as defined in claim 13,
the observation state being set corresponding to an in-focus object plane position of the near point image and the far point image, and
the exposure adjustment section adjusting the ratio corresponding to the in-focus object plane position.

15. The imaging apparatus as defined in claim 14,
the exposure adjustment section setting the ratio to a first ratio in a normal observation state, and
the exposure adjustment section setting the ratio to a second ratio that is larger than the first ratio in a magnifying observation state in which the in-focus object plane position is shorter than the in-focus object plane position in the normal observation state.

16. The imaging apparatus as defined in claim 12,
the exposure adjustment section adjusting the ratio so that a difference between an average luminance of an in-focus area of the near point image and an average luminance of an in-focus area of the far point image decreases.

17. The imaging apparatus as defined in claim 12,
the exposure adjustment section including at least one adjustable transmittance mirror divides reflected light from an object obtained by applying illumination light to the object into first reflected light and second reflected light, and
the at least one adjustable transmittance mirror dividing intensity of the first reflected light relative to intensity of the second reflected light by the variable ratio.

18. The imaging apparatus as defined in claim 12,
the exposure adjustment section including a division section that divides reflected light from an object obtained by applying illumination light to the object into first reflected light and second reflected light, and at least one variable aperture that adjusts intensity of the first reflected light relative to intensity of the second reflected light to the variable ratio.

19. The imaging apparatus as defined in claim 12,
the exposure adjustment section including a division section that divides reflected light from an object obtained by applying illumination light to the object into first reflected light and second reflected light, arid at least one liquid crystal shutter that adjusts intensity of the first reflected light relative to intensity of the second reflected light to the variable ratio.

20. The imaging apparatus as defined in claim 1, further comprising:
a focus control section that controls an in-focus object plane position,
the image acquisition section acquiring an image captured at a first timing at which the in-focus object plane position is set to a first in-focus object plane position as the near point image, and acquiring an image captured at a second timing at which the in-focus object plane position is set to a second in-focus object plane position as the far point image, the second in-focus object plane position differing from the first in-focus object plane position.

21. The imaging apparatus as defined in claim 20,
the exposure adjustment section adjusting the ratio of the exposure of the near point image to the exposure of the far point image by causing intensity of illumination light that illuminates an object to differ between the first timing and the second timing.

22. The imaging apparatus as defined in claim 20,
the synthetic image generation section including a motion compensation section that performs a motion compensation process on the near point image and the far point image, and
the synthetic image generation section generating the synthetic image based on the near point image and the far point image subjected to the motion compensation process.

23. An endoscope apparatus comprising:
an image acquisition section that acquires a near point image in which a near-point object is in focus, and a far point image in which a far-point object is in focus, the far-point object being positioned away as compared with the near-point object;
an exposure adjustment section that adjusts a ratio of exposure of the near point image to exposure of the far point image; and
a synthetic image generation section that selects a first area that is an in-focus area in the near point image and a second area that is an in-focus area in the far point image to generate a synthetic image,
the synthetic image generation section generating the synthetic image based on the near point image and the far point image acquired with exposure for which the ratio is adjusted.

24. An image generation method comprising:
acquiring a near point image in which a near-point object is in focus, and a far point image in which a far-point object is in focus, the far-point object being positioned away as compared with the near-point object;
adjusting a ratio of exposure of the near point image to exposure of the far point image;
selecting a first area that is an in-focus area in the near point image and a second area that is an in-focus area in the far point image to generate a synthetic image; and
generating the synthetic image based on the near point image and the far point image acquired with exposure for which the ratio is adjusted.
